(19) United States
(12) Patent Application Publication
(10) Pub. No.: US 2011/0010975 A1
(43) Pub. Date: Jan. 20, 2011

(54) Tag for fishing rod

(75) Inventor: Kazuhito Omura, Shizuoka-shi (JP)

Correspondence Address: BACON & THOMAS, PLLC, 625 SLATERS LANE, FOURTH FLOOR, ALEXANDRIA, VA, 22314-1176, US

(73) Assignee: FUJI KOGYO CO., LTD., Shizuoka-shi (JP)

(21) Appl. No.: 12/591,069

(22) Filed: Nov. 6, 2009

(30) Foreign Application Priority Data
Jul. 14, 2009 (JP) 2009-165519

(51) Int. Cl. G09F 3/04

(52) U.S. Cl. 40/663

(57) ABSTRACT

To solve the problems of a conventional tag for a fishing rod, which is floppily hung from a leg portion of a fishing line guide by using a cord etc. and its surface is often invisible to a customer, a tag (1) for a fishing rod is provided with an oblong sheet (3), two holes (9, 13) formed to be spaced in a longitudinal direction of the sheet, and two notches (11, 15) linearly extending from the respective holes to sheet edges, and the tag is attached to the fishing rod without flopping in a state that a customer appeal surface (17) between two holes is exposed at a fishing line guide side, by passing a leg portion (f) of a fishing line guide to one hole (9) via the notch (11), and passing a rod body (s) to the other hole (13) via the notch (15).

### BACKGROUND OF THE INVENTION

1. Field of the Invention

The present invention relates to a tag attached to a fishing rod.

2. Description of the Conventional Art

A fishing rod is sold in a state in which a fishing line guide or the like is attached to a rod body, in a retail shop. At that time, it is generally carried out to attach a tag as a promotion tool of the fishing rod or the guide.

### SUMMARY OF THE INVENTION

### Problem to be Solved by the Invention

A conventional tag 101 for a fishing rod is described in Japanese Unexamined Utility Model Publication No. 7-5367, and is attached in a hanging state to a leg portion f of a fishing line guide by using a cord or a rubber 103, as shown in FIG. 8.

However, if the tag is attached as mentioned above, the tag flaps at a time when a customer checks an action of the fishing rod by swinging it, and it is hard to check the rod action. Further, when the fishing rod is displayed at a store, there is often the case that a customer appeal surface, that is, a surface on which a manufacturer name, etc. are described does not always come to a visible position in the sight of a customer. In that case, it is necessary for the customer to check the tag one by one by holding it.

FIGS. 1 to 12 of Japanese Unexamined Utility Model Publication No. 7-5367 show a tag in accordance with other aspects. However, in a retail store, there is often the case that the fishing rod is displayed in a state in which a thread guide ring of a fishing line guide faces frontward. Accordingly, in the tag in accordance with the other aspects mentioned above, the customer appeal surface faces sideward so as to be hardly visible. Further, in a retail store, there is a case that a position of the tag is changed in consideration of its own circumstances, for example, a height of a shelf or a position of a lighting, however, it is not easy to detach and reattach the tag mentioned above. Further, in the tag mentioned above, a binding tool is necessary, and a manufacturing cost is increased.

Accordingly, in order to solve the problems mentioned above, an object of the present invention is to provide a tag for a fishing rod in which a shape is devised.

### Means for Solving the Problems

The inventor of the present invention has, as a result of devoting himself to make a study, confirmed that a plurality of problems can be simultaneously solved, while having a simple shape, by providing a hole and a notch for opening the hole to a sheet edge at each of both end sides in a longitudinal direction of an oblong sheet, and structuring such as to pass a rod body to one hole and pass a leg portion of a fishing line guide to the other hole, thereby the sheet being attached, and finishes the present invention.

In accordance with a first aspect of the present invention, there is provided a tag for a fishing rod comprising:

an oblong sheet;

two holes formed so as to be spaced in a longitudinal direction of the sheet; and

two notches linearly extending from the respective holes to sheet edges,

wherein the tag is attached to the fishing rod in a state in which a sheet surface between the two holes is set at a front side of the rod body, by passing a leg portion of a fishing line guide to the one hole via the notch, and passing the rod body to the other hole via the notch.

In accordance with a second aspect of the present invention, there is provided a tag for a fishing rod as recited in the first aspect, wherein a fold extending linearly to the sheet edges at both ends in a sheet lateral direction is provided so as to cross over a hole edge of the rod body attaching hole or to be closer to the center in a sheet longitudinal direction from the hole edge.

In accordance with a third aspect of the present invention, there is provided a tag for a fishing rod as recited in the second aspect, wherein the rod body attaching side notch extends from the rod body attaching hole to the sheet edge at the end in the sheet longitudinal direction, a pair of folds are provided at both sides of the hole edge of the rod body attaching hole, and each of the folds extends diagonally so as to come close to the center side in the sheet longitudinal direction little by little toward the sheet edge.

In accordance with a fourth aspect of the present invention, there is provided a tag for a fishing rod as recited in any one of the first to third aspects, wherein the tag is provided with a pair of engagement extending portions extending in an opposed manner so as to come close to an outer peripheral surface of the rod body within the rod body attaching hole.

In accordance with a fifth aspect of the present invention, there is provided a tag for a fishing rod as recited in any one of the first to fourth aspects, wherein the leg portion attaching side notch extends from an intermediate portion in the sheet lateral direction of the leg portion attaching hole to the sheet edge at the end in the sheet longitudinal direction, and is provided with a pair of flaps extending within the leg portion attaching hole and respectively closing both end sides in the sheet lateral direction.

### Effect of the Invention

The tag for the fishing rod in accordance with the present invention can be firmly attached to the fishing rod without swaying or rattling, and a customer appeal surface can be stably brought to a thread guide ring side of the fishing line guide. Further, since the other raw materials such as the cord or the like than the sheet are not necessary, a manufacturing cost is reduced. Further, it is easy to attach and detach the tag, and it is possible to reattach it again and again.

In addition, in the tag for the fishing rod in accordance with the present invention, since only the leg portion passes through the notch at a time of installing the one hole to the fishing line guide, the tag manufactured uniformly can be attached in a general-purpose manner even if a magnitude of the thread guide ring is different or regardless of one leg or two legs.

### BRIEF EXPLANATION OF DRAWINGS

FIGS. 1(A) and 1(B) are perspective views of a tag for a fishing rod in accordance with a first embodiment of the preset invention and the fishing rod to which it is attached;

FIG. 2 is a perspective view showing a state in which the tag for the fishing rod in FIG. 1 is attached to the fishing rod;

FIG. 3 is a perspective view showing a state in which a tag for a fishing rod in accordance with a second embodiment is attached to the fishing rod;

FIGS. 4(A), 4(B) and 4(C) are a plan view of a tag for a fishing rod in accordance with a third embodiment, and perspective views showing a state in which it is attached to the fishing rod;

FIGS. 5(A) and 5(B) are a plan view of a tag for a fishing rod in accordance with a fourth embodiment, and a perspective view showing a state in which it is attached to the fishing rod;

FIGS. 6(A), 6(B) and 6(C) are a plan view of a tag for a fishing rod in accordance with a fifth embodiment, and perspective views showing a state in which it is attached to the fishing rod;

FIG. 7 is a plan view of a tag for a fishing rod in accordance with a sixth embodiment; and

FIG. 8 is a perspective view showing a state in which a conventional tag for a guide is attached to a fishing rod.

### DETAILED DESCRIPTION OF PREFERRED EMBODIMENT

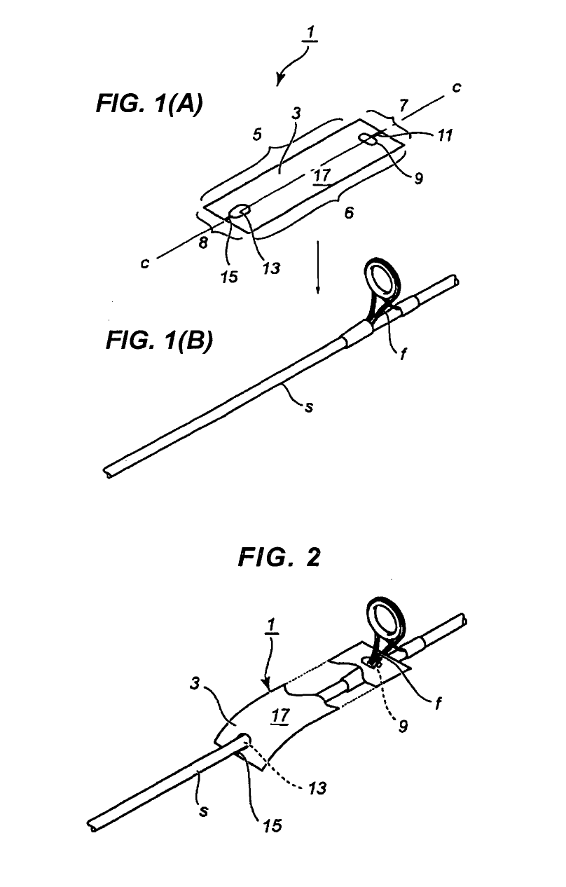

A description will be given of a tag 1 for a fishing rod in accordance with a first embodiment of the present invention with reference to FIGS. 1(A), 1(B) and 2.

The tag 1 for the fishing rod is formed by one paper. A sheet 3 constructing a main body is formed in an oblong rectangular shape, and sheet edges 5 and 6 defining both ends in a lateral direction and sheet edges 7 and 8 defining both ends in a longitudinal direction are opposed in parallel to each other respectively.

A leg portion attaching hole 9 is formed close to the sheet edge 7 of the sheet 3. The leg portion attaching hole 9 is formed in an oval shape which is long in the sheet lateral direction, while crossing over a center line c in the longitudinal direction of the sheet 3, and is symmetric with respect to the center line c. Reference numeral 11 denotes a notch, and the notch 11 extends linearly from the sheet edge 7 side of the leg portion attaching hole 9 so as to reach the sheet edge 7 directly. The notch 11 exists on the center line c. Accordingly, the leg portion attaching hole 9 is open to the sheet edge 7 side via the notch 11.

A rod body attaching hole 13 is formed at the sheet edge 8 side of the sheet 3. The rod body attaching hole 13 is formed in an approximately oval shape which is long in the sheet longitudinal direction, while crossing over the center line c in the longitudinal direction of the sheet 3, and is symmetric with respect to the center line c. Reference numeral 15 denotes a notch, and the notch 15 extends linearly from the sheet edge 8 side of the rod body attaching hole 13 so as to reach the sheet edge 8 directly. The notch 15 exists on the center line c. Accordingly, the rod body attaching hole 13 is open to the near side, i.e. the sheet edge 8 side via the notch 15.

The tag 1 for the fishing rod having the structure mentioned above is attached to the fishing rod, as shown in FIG. 2.

Specifically, a leg portion f of a fishing line guide is guided into the leg portion attaching hole 9 by opening the notch 11 up and down, right and left, and passing the leg portion f of the fishing line guide to a gap thereby made. Further, a rod body s is guided into the rod body attaching hole 13 by opening the notch 15 up and down, right and left, and passing the rod body s to a gap thereby made.

Since there is achieved an attitude in which one end side of the tag 1 is retained to the leg portion f, and the other end side is retained to the rod body s, by attaching it as mentioned above, the tag can be firmly attached to the fishing rod without swaying or rattling.

Further, a main sheet surface between the leg portion attaching hole 9 and the rod body attaching hole 13, that is, a customer appeal surface 17 faced to the fishing line guide side is brought to a front side of the rod body s, by attaching it as mentioned above.

In addition, since the tag is attached without using any cord or the like, it is easy to attach and detach it. Further, the notches 11 and 15 may become hard to return back each time when they are attached, and become open little by little, however, since the notches 11 and 15 hide behind the leg portion f and the rod body s, they are unremarkable at a time of being displayed at a store.

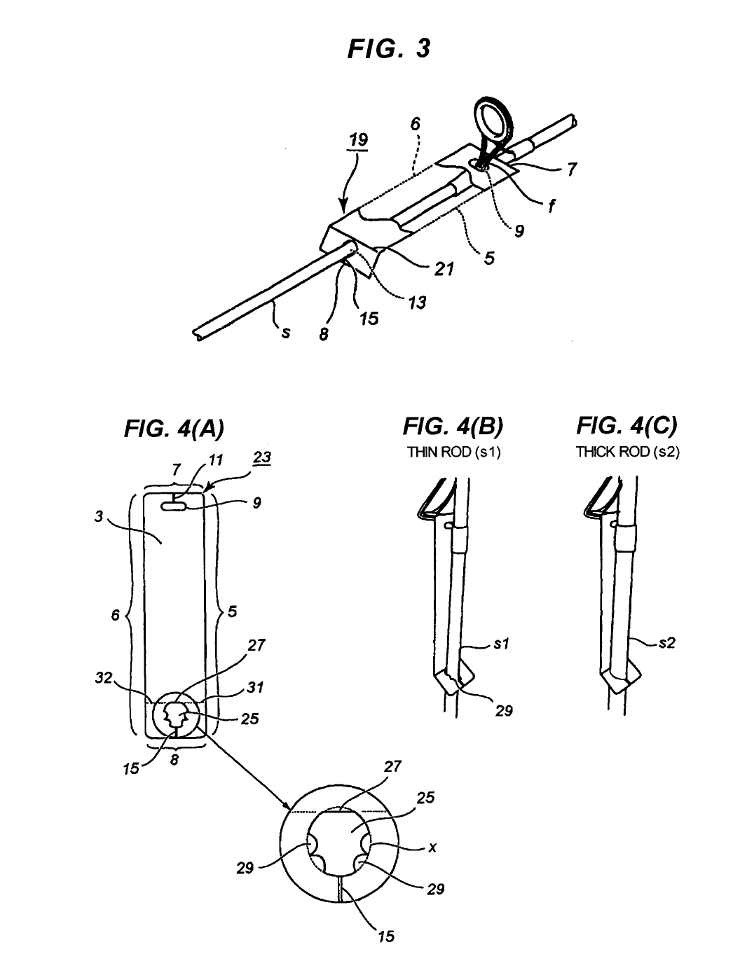

A description will be given of a tag 19 for a fishing rod in accordance with a second embodiment of the present invention with reference to FIG. 3.

The tag 19 for the fishing rod is different from the tag 1 for the fishing rod in accordance with the first embodiment in a point that a fold 21 is formed to be further slightly close to the center than the hole edge at the center side in the sheet longitudinal direction of the rod body attaching hole 13. The fold 21 extends linearly in parallel to the sheet edges 7 and 8 between the sheet edges 5 and 6.

The fold 21 is mountain folded in such a manner that the customer appeal surface 17 comes to the front side, and is thereafter attached to each of the leg portion f of the fishing line guide and the rod body s in the same manner as the tag 1 for the fishing rod.

If the fold 21 is mountain folded, the rod body attaching hole 13 exists on an uprising surface, that is, a surface intersecting the rod body s at an angle which is close to the vertical. Accordingly, even after the rod body s is inserted to the rod body attaching hole 13, the customer appeal surface 17 keeps a flat state without being curved, and is more easily visible.

A description will be given of a tag 23 for a fishing rod in accordance with a third embodiment of the present invention with reference to FIGS. 4(A), 4(B) and 4(C).

In the tag 23 for the fishing rod, a shape of a rod body attaching hole 25 and a position of a fold are different from the tag 19 for the fishing rod in accordance with the second embodiment. A hole edge of the rod body attaching hole 25 is set on the basis of an approximately circular locus x, and is cut linearly at the center side in a sheet longitudinal direction, and a cut edge 27 is in parallel to the sheet edges 7 and 8. Further, engagement extending portions 29 like as humps of a camel with two humps extend in the hole from both sides in a lateral direction close to the sheet edge 8 side. Accordingly, the engagement extending portions 29 extend in such a manner as to come close to an outer peripheral surface of the rod body s to be passed.

Further, folds 31 and 32 extend respectively to the sheet edges 5 and 6 from both ends in the lateral direction of the cut edge 27, and become parallel to the sheet edges 7 and 8.

In this case, corner portions of the sheet 3 are rounded small in order not to be bent.

After the folds 31 and 32 are mountain folded in such a manner that the customer appeal surface 17 comes to the front side, the rod body s is passed through the rod body attaching hole 25.

In the case that a thin rod s1 is passed through the rod body attaching hole 25, not only the hole edges at both end sides in the sheet longitudinal direction, but also ends of the engagement extending portions 29 come into contact with both sides of the thin rod s1 so as to come to an attitude that the thin rod s firmly retains the tag. Accordingly, it is possible to firmly attach the tag to the fishing rod without rattling.

On the other hand, in the case that a thick rod s2 is passed through the rod body attaching hole 25, the engagement extending portions 29 are bent, and those bending portions come into contact with both sides of the thick rod s2 so as to come to an attitude that the thick rod s2 firmly retains the tag. Accordingly, it is possible to firmly attach the tag to the fishing rod without rattling as well. Further, since the rod body attaching hole 25 is not expanded constrainedly, a crack is not formed around the hole.

As mentioned above, the embodiment can be applied either to the thin rod s1 or to the thick rod s2.

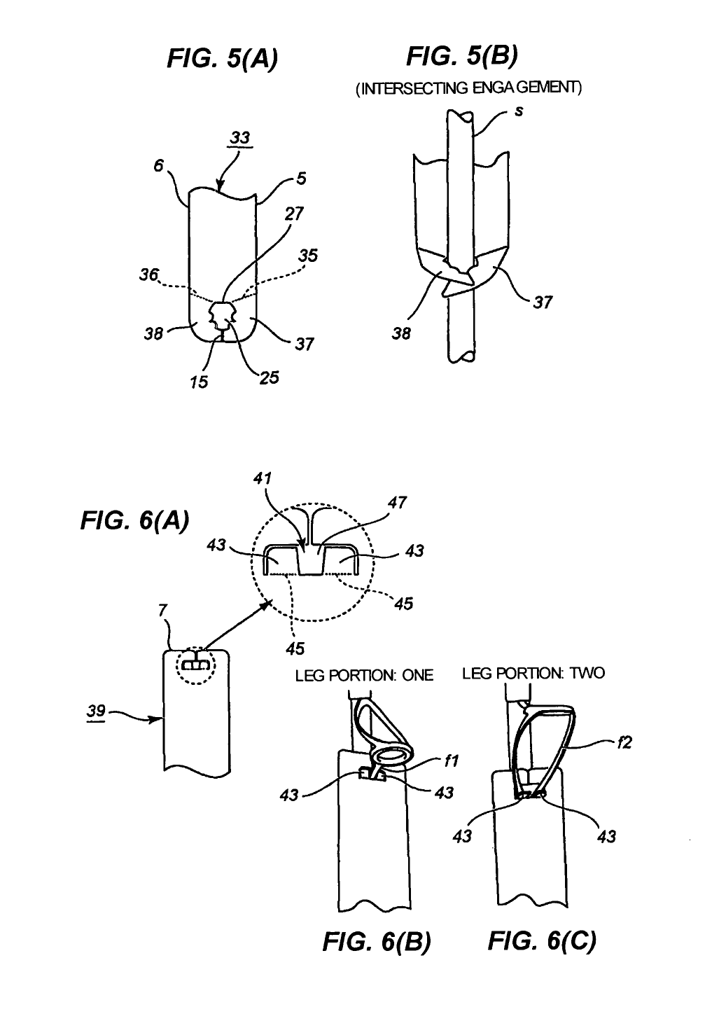

A description will be given of a tag 33 for a fishing rod in accordance with a fourth embodiment of the present invention with reference to FIGS. 5(A) and 5(B).

In the tag 33 for the fishing rod, folds 35 and 36 are different from those of the tag 23 for the fishing rod in accordance with the third embodiment.

The folds 35 and 36 extend diagonally in such a manner as to come close to the center side in the sheet longitudinal direction little by little toward the sheet edges 5 and 6 respectively from both ends in the sheet lateral direction of the cut edge 27. Forward portions beyond the folds 35 and 36 form fold-in pieces 37 and 38, and corner portions are largely rounded in order to be easily folded in.

If the folds 35 and 36 are mountain folded, the fold-in pieces 37 and 38 at the forward portions beyond the folds 35 and 36 intersect each other so as to be engaged. Accordingly, the rod body s is further hard to be detached from the rod body attaching hole 25.

A description will be given of a tag 39 for a fishing rod in accordance with a fifth embodiment of the present invention with reference to FIGS. 6(A), 6(B) and 6(C).

In this tag 39 for the fishing rod, a shape of a leg portion attaching hole 41 is different from the tag 23 for the fishing rod in accordance with the third embodiment.

A hole edge of the leg portion attaching hole 41 is formed in a rectangular shape which is long in the sheet lateral direction, and corner portions close to the sheet edge 7 is rounded small.

A pair of flaps 43 and 43 extend from the sheet center side toward the sheet edge 7 within the hole. Each of the flaps 43 is formed in an approximately rectangular shape along the hole edge, and almost closes each of both end sides in the sheet lateral direction within the hole. A fold 45 is formed at a base end side of each of the flaps 43. A gap 47 is left between the flaps 43 and 43.

Further, the notch 11 is rounded at an opening end side, and is expanded right and left widely toward for the open end.

In the case that the leg portion f1 is comparatively thin such as the case of one leg portion, it is passed through the gap 47 as it is. In this case, since the respective flaps 43 come into contact with both sides of one leg portion f1 so as to come to an attitude that they firmly retain the tag, it is possible to firmly attach the tag to the fishing rod without rattling.

On the other hand, in the case that the leg portion is comparatively wide such as the case of two leg portions, the flaps 43 and 43 are valley folded at the folds 45 and 45 so as to be stood, and pass them in a state in which the leg portion attaching hole 41 is fully opened. In this case, since the hole edge of the leg portion attaching hole 41 comes into contact with both sides of two leg portions f2 so as to come to an attitude that they firmly retain the tag, it is possible to firmly attach the tag to the fishing rod without rattling.

As mentioned above, even if the number and the thickness of the leg portion of the fishing line guide are different, it is possible to apply this embodiment.

Further, since the notch 11 is expanded at the open end side, it can easily pass the leg portions f1 and f2.

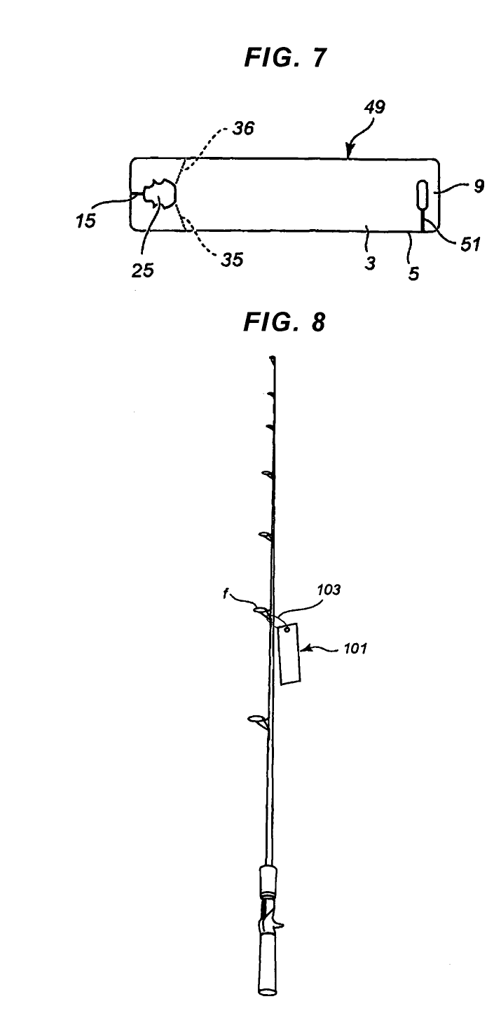

A description will be given of a tag 49 for a fishing rod in accordance with a sixth embodiment of the present invention with reference to FIG. 7.

This tag 49 for the fishing rod is different from the tag 33 for the fishing rod in accordance with the fifth embodiment in a point that a notch 51 at the leg portion attaching hole 9 side extends to the sheet edge 5 side.

As mentioned above, a position of the notch can be appropriately changed.

The description is given of the embodiments in accordance with the present invention as above, however, the specific structure of the present invention is not limited to the embodiments mentioned above, but a design change within the scope of the present invention is included in the present invention.

For example, in the embodiments mentioned above, the sheet is formed by a paper in all the embodiment, however, the sheet may be formed by a plastic.

Further, in the fifth embodiment, the flap 43 extends from the sheet center side toward the sheet edge 7, however, may contrarily extends from the sheet edge 7 side toward the sheet center side, or may be extended from the sheet edges 5 and 6 sides.

In any case, except the shapes and the like which are claimed, it is possible to optionally combine shapes, raw materials and manufacturing methods which have been conventionally provided, or will be excogitated in the future.

### INDUSTRIAL APPLICABILITY

In accordance with the tag for the fishing rod guide on the basis of the present invention, since it is possible to form it only by the sheet material, not only it is easy to manufacture, but also it is possible to reduce the manufacturing cost in comparison with the case that the cord or the like is used together.

Further, if the notch exists in the customer appeal surface, it is hard to make alignment at a time of printing a pattern or the like thereon, however, in accordance with the tag for the fishing rod, it is easy to print owing to no notch.

What is claimed is:

1. A tag for a fishing rod comprising:
an oblong sheet;
two holes formed so as to be spaced in a longitudinal direction of said sheet; and
two notches linearly extending from the respective holes to sheet edges,
wherein the tag is attached to the fishing rod in a state in which a sheet surface between said two holes is set at a front side of said rod body, by passing a leg portion of a fishing line guide to the one hole via the notch, and passing the rod body to the other hole via the notch.

2. A tag for a fishing rod as claimed in claim 1, wherein a fold extending linearly to the sheet edges at both ends in a sheet lateral direction is provided so as to cross over a hole edge of the rod body attaching hole or to be closer to the center in a sheet longitudinal direction from said hole edge.

3. A tag for a fishing rod as claimed in claim 2, wherein the rod body attaching side notch extends from the rod body attaching hole to the sheet edge at the end in the sheet longitudinal direction, a pair of folds are provided at both sides of the hole edge of said rod body attaching hole, and each of the folds extends diagonally so as to come close to the center side in the sheet longitudinal direction little by little toward the sheet edge.

4. A tag for a fishing rod as claimed in claim 1, wherein the tag is provided with a pair of engagement extending portions extending in an opposed manner so as to come close to an outer peripheral surface of the rod body within the rod body attaching hole.

5. A tag for a fishing rod as claimed in claim 2, wherein the tag is provided with a pair of engagement extending portions extending in an opposed manner so as to come close to an outer peripheral surface of the rod body within the rod body attaching hole.

6. A tag for a fishing rod as claimed in claim 3, wherein the tag is provided with a pair of engagement extending portions extending in an opposed manner so as to come close to an outer peripheral surface of the rod body within the rod body attaching hole.

7. A tag for a fishing rod as claimed in claim 1, wherein the leg portion attaching side notch extends from an intermediate portion in the sheet lateral direction of the leg portion attaching hole to the sheet edge at the end in the sheet longitudinal direction, and is provided with a pair of flaps extending within said leg portion attaching hole and respectively closing both end sides in the sheet lateral direction.

8. A tag for a fishing rod as claimed in claim 2, wherein the leg portion attaching side notch extends from an intermediate portion in the sheet lateral direction of the leg portion attaching hole to the sheet edge at the end in the sheet longitudinal direction, and is provided with a pair of flaps extending within said leg portion attaching hole and respectively closing both end sides in the sheet lateral direction.

9. A tag for a fishing rod as claimed in claim 3, wherein the leg portion attaching side notch extends from an intermediate portion in the sheet lateral direction of the leg portion attaching hole to the sheet edge at the end in the sheet longitudinal direction, and is provided with a pair of flaps extending within said leg portion attaching hole and respectively closing both end sides in the sheet lateral direction.

10. A tag for a fishing rod as claimed in claim 4, wherein the leg portion attaching side notch extends from an intermediate portion in the sheet lateral direction of the leg portion attaching hole to the sheet edge at the end in the sheet longitudinal direction, and is provided with a pair of flaps extending within said leg portion attaching hole and respectively closing both end sides in the sheet lateral direction.

11. A tag for a fishing rod as claimed in claim 5, wherein the leg portion attaching side notch extends from an intermediate portion in the sheet lateral direction of the leg portion attaching hole to the sheet edge at the end in the sheet longitudinal direction, and is provided with a pair of flaps extending within said leg portion attaching hole and respectively closing both end sides in the sheet lateral direction.

12. A tag for a fishing rod as claimed in claim 6, wherein the leg portion attaching side notch extends from an intermediate portion in the sheet lateral direction of the leg portion attaching hole to the sheet edge at the end in the sheet longitudinal direction, and is provided with a pair of flaps extending within said leg portion attaching hole and respectively closing both end sides in the sheet lateral direction.
